(19) United States
(12) Patent Application Publication
(10) Pub. No.: US 2021/0209866 A1
(43) Pub. Date: Jul. 8, 2021

(54) HYBRID COMPUTERIZED INDICIA PRINTING SYSTEM

(71) Applicant: Neopost Technologies, Bagneux (FR)

(72) Inventors: Cindy Mangiameli, Southbury, CT (US); Jonathan Siemasko, Naugatuck, CT (US); Kirk Lane Wilson, Stratford, CT (US)

(21) Appl. No.: 16/733,671

(22) Filed: Jan. 3, 2020

(51) Int. Cl. G07B 17/00

(52) U.S. Cl. CPC G07B 17/00314; G07B 17/00508; G07B 2017/0058; G07B 2017/00548; G07B 2017/00556

(57) ABSTRACT

A limited-function computing device is provided that allows a user to print postage indicia or other value-bearing items on demand, without requiring the user to log in to or otherwise access specialized software executing on a general-purpose computer.

### BACKGROUND

Modern postal delivery systems for delivering mail pieces, parcels and packages make use of various types of postage evidencing systems (PES). A PES is a product or system that includes an electronic postal meter, such as a Postal Security Device (PSD). A PSD includes an ascending register and a descending register that each function in the same way as in a mechanical postage meter. However, the PSD does not include a metal die for printing indicia. Instead, the PSD produces a secure data record representing meter-generated evidence of prepaid postage that may be communicated to a printing device and printed directly or indirectly on to mail items. Such meter-generated evidence may include an electronic stamp, also known as an IBI (Information-Based Indicia) or an IMI (Intelligent Mail Indicia). In a conventional PSD environment, a meter (or PSD) reset may occur by connecting to a meter resetting system, such as a computerized meter resetting system (CMRS), which is operated by an authorized vendor.

A PSD may be physical or virtual and may exist in a “closed” or an “open” PES environment. A “closed” PES environment, as exemplified by the mechanical postage machines described above, and franking machines first launched in the late 1800s, typically includes a physical postal meter.

In a closed PES environment, a postal service provider or authorized vendor may lease the postal meter to a customer. A customer is required to have funds available on deposit with the provider or the vendor before resetting a PES, or the vendor may opt to provide a funds advance in accordance with appropriate regulations.

An “open” PES environment typically includes a virtual meter that is managed by an authorized vendor. In an open PES environment, the meter may be accessible by one or more customers; the authorized vendor pays the postal service provider, such as the USPS, for the postage purchased by the customer and the customer pays the authorized vendor.

“PC Postage” is an example of an open PES environment and was launched by the USPS in 1999. PC Postage is a system that provides customers with an online alternative to standing in line or using a postage meter to purchase postage for their outgoing mail. In conjunction with the launch of this program, the USPS certified and authorized vendors to offer PC Postage services to consumers. To use PC Postage, a consumer may install an authorized vendor's software application on their local computer, set up a payment account with the authorized vendor, and use the authorized vendor portal to access through the internet to a PSD to obtain an indicia.

As used herein, the term “mail” generally refers to mail pieces, parcels and packages that are shipped by service providers including the USPS and other national or international postal services, as well as foreign and domestic commercial shipping service providers including, for example, Federal Express®, DHL®, and UPS®.

### BRIEF SUMMARY

Embodiments disclosed herein provide methods, systems and devices for generating paid postage on demand. In an embodiment, a device or system is provided that includes a limited-function computing device and a printing device. The limited-function computing device may include a remote communication interface capable of being configured to communicate with a remote postage platform; a first local communication interface; a physical user interface; and a processor configured to receive input via the physical user interface and to send and receive electronic communications via the remote communication interface and the first local communication interface. The printing device may include a second local communication interface capable of being configured to communicate with the limited-function computing device via the first local communication interface; and a printer. The limited-function computing device is capable of being configured to send postage indicia to the printing device to be printed in response to receiving an input via the physical user interface.

In an embodiment, a limited-function computing device is provided that includes a remote communication interface capable of being configured to communicate with a remote postage platform; a first local communication interface capable of being configured to communicate with a device physically connected to the limited-function computing device; a physical user interface; and a processor configured to receive input via the physical user interface and to send and receive electronic communications via the remote communication interface and the first local communication interface. The limited-function computing device is capable of being configured to send a postage indicia to a printer via the first local communication interface in response to receiving an input via the physical user interface.

In an embodiment, a method of providing postage indicia is provided that includes receiving an input signal via a physical user interface by a limited-function computing device; verifying that sufficient funds exist, in an account linked to the limited-function computing device, to generate a postage indicia; and responsive to the input signal and the verifying, instructing a printing device to print a postage indicia.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1A shows a schematic representation of an example limited-function computing device in communication with an example remote platform according to an embodiment of the disclosed subject matter.

FIG. 1B shows a schematic representation of an example limited-function computing device in communication with a remote platform and an example general purpose computer according to an embodiment of the disclosed subject matter.

FIG. 1C shows an illustration of an example limited-function computing device in communication with an example printing device according to an embodiment of the disclosed subject matter.

FIG. 1D shows an illustration of an example limited-function computing device that includes an integrated printing device according to an embodiment of the disclosed subject matter.

FIG. 2 shows an example of communication and data flow according to an embodiment of the disclosed subject matter.

FIG. 3 shows an example computer architecture suitable for implementing embodiments of the disclosed subject matter.

### DETAILED DESCRIPTION

Conventional PC postage and similar open PES systems typically require a user to use specialized software installed on a general purpose computing device such as a desktop, laptop, tablet, or similar device, which is also connected to a secure peripheral that prints postage indicia under the control of the specialized software. The user generally must log in to the specialized software to access the user's account information and stored postage value, which typically is managed by a remote service. For example, the user may “load” the PC postage account by making payment via credit card or other source(s) of funds. The specialized software provides access to the stored funds, which may be stored locally and/or at a remote management system. The user then uses the software to generate postage using the stored funds. The postage is printed by a peripheral, such as a conventional printer or a specialized secure printing device. In a conventional PC postage system, the printer is prevented from printing postage when it is not connected to and under the control of the specialized software. Similarly, PC postage systems typically include software and/or hardware mechanisms to prevent printing the same postage indicia more than once or otherwise duplicating and using legitimate indicia, transfer value to or from the managed postage account outside of the specialized software, and otherwise maintain the security of the system and the user's account and stored funds. As such, the user must log in to and operate the specialized software in each case that he prints postage indicia. This can be particularly inefficient when, for example, only a small number of postage indicia are desired.

Embodiments disclosed herein address these and other shortcomings of conventional postage systems, including closed systems, PC postage systems, and other open postage systems. In embodiments disclosed herein, a simple physical device may be used to print postage indicia as required by the user, without requiring the user to log in to a secure, managed, specialized software system to do so. In some cases, the user may generate postage indicia simply by pushing a button or operating another similar input interface. Some embodiments also may provide a mechanism for a user to indicate an amount and/or quantity of indicia to be printed, also without requiring the user to log in to specialized software or otherwise directly access a postage value account or management service.

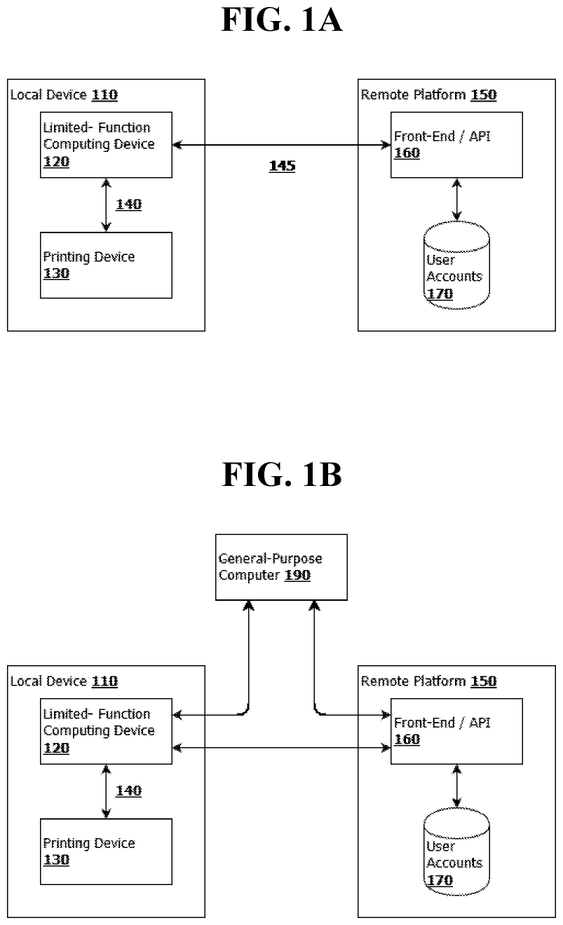

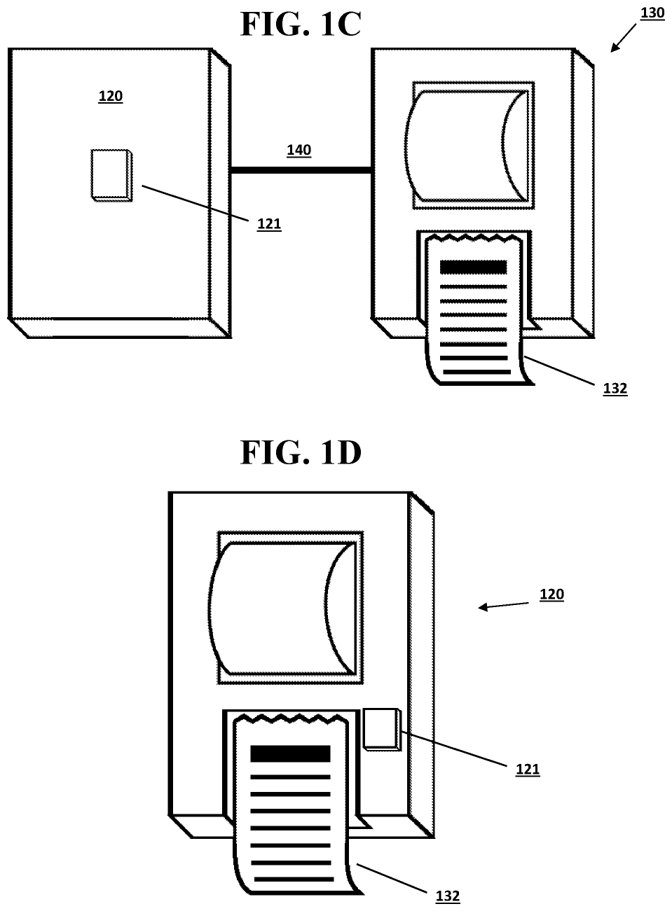

FIG. 1A shows an example device 110 according to an embodiment disclosed herein. The device 110 may be implemented as, and may be described herein as, a single physical device, or it may be implemented as multiple physical devices that are physically and/or communicatively connected to one another. Unless specifically described in a particular arrangement herein, in general the device 110 may be single or multiple devices. The device 110 includes a limited-function computing device 120, which also may be referred to as a limited-purpose or simplified computing device. The limited-function computing device 120 may differ from a conventional, general-purpose computer such as a laptop, desktop, tablet, or similar computing device in that it may have a limited user interface and may have more limitations in hardware and/or software. For example, a limited-function computing device as disclosed herein may not include the capability for a user to install additional software on the device or otherwise modify its operation from the functionality with which it is provided to the user. The limited-function computing device 120 may include software and/or hardware controls to prevent modification of its functionality, including installation or alteration of software, or it may simply not include any mechanism for a user to change the functionality of the device. For example, operational commands of the device may be stored in a computer-readable medium that is not accessible or not modifiable by a user. However, as disclosed in further detail herein, in some embodiments the limited-function computing device 120 may include a mechanism for a remote management platform to update or otherwise modify the operation of the limited-function computing device.

The local device 110 may be a single integral physical device that includes the limited-function computing device 120 and the printing device 130. However, in some configurations it may be preferable for the limited-function computing device 120 to be physically separate and distinct from the printing device 130. For example, the limited-function computing device may 120 be a device that is provided to customers of a remote platform 150 as further disclosed herein, who then may use any available printing device 130 that meets minimum requirements such as resolution, print size, form factor, etc., which may be determined by other considerations of the user. Such an arrangement may be preferred because it allows for greater flexibility in the style and type of printing device 130 that may be used by an end user.

Still referring to FIG. 1A, the limited-function computing device 120 may include a local communication interface that allows the limited-function computing device to be connected to, and to provide instructions to a local printing device 130. The connection 140 may be a physical connection made via serial, ethernet, universal serial bus (USB) of any version, or similar connection, or it may be via a wireless connection such as Wi-Fi, Bluetooth®, near-field communication (NFC), or other wireless connection.

The limited-function computing device 120 also may include a remote connection interface 145 that can be configured to communicate with a remote postage platform 150. Most commonly, the remote connection interface 145 may be a wired or wireless network connection, such as an ethernet or Wi-Fi connection, which connects the device 120 to the remote platform 150 via a local area network, wide area network, the Internet, or a combination thereof. For example, the limited-function computing device may include a wireless network module that allows it to connect to a local area network such as a home or business network. Via this local network, the device 120 may communicate with the printing device 130 and/or the remote platform 150. That is, the remote communication interface and the local communication interface may be implemented via a single physical component such as a single network interface, while providing separate communication channels to the corresponding devices. Alternatively, the limited-function computing device 120 may include separate physical communication interfaces for each, such as where the device 120 communicates with the printing device 130 via a short-range wireless connection such as NFC or Bluetooth® and communicates with the remote platform 150 via a wired or wireless network connection as previously disclosed.

The remote platform 150 may manage user accounts, stored funds, and the like, as may be used in conventional PC postage systems. That is, the funds provided by a user may be stored at the remote platform 150 instead of locally at the limited-function computing device 120. As disclosed in further detail herein, in operation the limited-function computing device 120 may receive data sufficient to generate a postage indicia from the remote platform 150, which then accounts for the postage in one or more user accounts. Conceptually, the remote platform 150 may manage virtual PSD-type accounts, including ascending registers, descending registers, or the like, or a more general account value as may be used in other PC postage style systems. The remote platform 150 may include a front-end or application programming interface (API) 160 that provides a way for one or more devices that are remote from the platform 150, such as device 110, to send requests, receive authentication, authorization, postage indicia or indicia images and/or postage data, or the like. The front-end interface 160 may access one or more user accounts 170 stored and managed by the remote platform 150 as will be readily understood by one of skill in the art. A user account 170 may store information about a limited-function computing device 120, such that each device 120 is connected to a single user account 170. The user account 170 may include the stored funds available to the owner of the device 120, which may be provided and replenished as previously described and as disclosed in further detail herein. In some cases, the stored funds available to a user account, and thus to a device 120, may be automatically replenished when the value falls below a specified level, such as via automatic charges to a funding source provided by the user.

Notably, embodiments disclosed herein may allow for a user to print postage indicia via the local device 110 without needing to directly access the remote platform 150, or to log in to specialized software executed by a general-purpose computer as is required by conventional PC postage systems. For example, a user may operate a limited user interface, such as a simple button or switch on the limited-function computing device 120. The device 120 may then communicate with the remote platform 150 to determine that an indicia should be printed, for example by verifying that the device 120 is authorized to generate an indicia, that sufficient stored funds are available in a user account associated with the device 120, or the like, as disclosed in further detail herein. The device 120 may then generate and/or provide the indicia to the printing device 130. In contrast to conventional PC postage and similar systems, the user need not ever access an interface to the remote platform 150 or execute any software on a general-purpose computer or any device other than the limited-function computing device 120. Thus, the user may obtain one or more postage indicia simply by activating a button or other simple interface on the limited-function computing device, greatly simplifying the process for the user compared to conventional systems.

Furthermore, in an embodiment it may not be necessary for a user to interact with the remote platform 150 in any capacity other than via the limited-function computing device 120 as previously disclosed. For example, a user may purchase the device 120 from a provider of postage services that also provides the remote platform 150. In conjunction with obtaining the device 120, the user may provide a funding mechanism for postage to be obtained via the device, such as a credit card that the user authorizes the provider to charge as appropriate to maintain sufficient funds to create indicia, a bank account or other funding source that may be linked to the device 120 such as via the remote platform 150, or the like. After that, the device 120 may operate as disclosed herein without requiring the user to interact with the remote platform 150 or the provider that maintains the remote platform 150. As a specific example, a user may purchase the limited-function computing device 120 from a postage services provider that operates a remote platform 150 as disclosed herein. At the time of purchase, the user may provide authorization for the remote platform 150 to charge a credit card of the user at regular intervals, at any time that the stored funds in the user account 170 associated with the user falls below a set threshold, each time the user requests postage via the device 120, or the like. The user may then install the device 120 with a printing device 130 by connecting the device 120 to the printing device 130 and to a communication network as previously disclosed. Alternatively, the device 120 and printing device 130 may be a single, integrated, inseparable unit as it is obtained by the user. That is, in some cases a single local device 110 may perform the functions described herein with respect to device 120 and printing device 130, such that there is no discernable distinction to the user between the device 120 and the printing device 130. In some cases, the device 120 may be configured to automatically connect to a local network as previously disclosed, or it may be connected by the user via a user interface, an app on a phone, tablet, or computer, or the like. Once connected, the device 120 may access the remote platform 150 and receive an indication from the platform 150 that it is properly configured and authorized to print postage indicia.

Alternatively, a general-purpose computer may be used to configure the limited-function computing device 120 initially and/or to provide maintenance functions, such as “reloading” the postage value in an account associated with the device. FIG. 1B shows such an arrangement, in which a computing device 190 provides various one-time or occasional functionality for the device 120. When used, the computer 190 may provide a gateway connection for the device 120 to access the remote platform 150. For example, the device 120 may initially connect to the computer 190 via a local network, direct physical connection, or the like, and the computer 190 may provide for communication between the remote platform 150 and the device 120. Alternatively or in addition, the computer 190, device 120, and remote platform 150 all may communicate with one another via local networks and wide-area networks such as the Internet. As a specific example, the limited-function computing device 120 may be connected initially to the computer 190 to initialize the device 120. The remote platform 150 may verify the device 120, such as by comparing information (such as a username, passcode, serial number or other unique identifier, or the like) received from a user via the computer 190 to information received from the computing device 120 to verify that the device is in possession of the user associated with a user account 170 linked to the device 120. The user also may provide funding information such as a credit card, bank account, or the like via the computer 190 to provide funding for postage to be generated by the device 120. The remote platform 150 also may use the computer 190 and a user interface provided via the computer 190 to perform initial setup, validation, authorization, or the like with regard to the device 120, a user account 170, or combinations thereof. In some cases, a general-purpose computer also may be used to change configuration settings, options, or the like, after the initial configuration and setup disclosed above. For example, a user may use a general-purpose computer such as a desktop, laptop, phone, tablet, or the like to update the credit card associated with the device 120, to change thresholds at which funding amounts are automatically added to the user's account, or the like.

After the device 120 has been configured using the general-purpose computer 190, the computer 190 may no longer be needed for operation of the device 120 to provide postage indicia, as previously disclosed. In some embodiments, a computer 190 may be used intermittently, such as to provide new funds for use in generating postage indicia, to receive and install software updates on the device 120, or the like. However, generally the computer 190 will not be required for regular operation of the device 120, thereby avoiding the software and operational overhead typically associated with conventional PC postage systems, as previously disclosed.

Regardless of how the device is initialized, the device 120 may be uniquely connected to a user account 170 by the remote platform 150. For example, where the device is automatically configured after being connected to the remote platform 150, the remote platform 150 may obtain a unique identifier from the device 120 and verify that the identifier is associated with a user account 170, such as where the user account was established during initial purchase of the device 120 by the user. As another example, when the device is configured later with a general-purpose computer, a user may enter a unique identifier that is on or provided by the device to the remote platform 150, which then may link the identifier to the user account.

In an embodiment, the limited-function computing device 120 may be configured to communicate only with the remote platform 150. For example, cryptographically-secure communications techniques may be used so that the device 120 will only respond to a properly-signed communication. Alternatively or in addition, a processor in the limited-function device 120 may be configured to send and receive communications only with the remote platform 150 and to reject or ignore communications from any other source.

A printing device 130 as disclosed herein may include a local communication interface for communicating with the limited-function computing device 120 as previously disclosed and a printer for printing postage indicia. The local communication interface may be, for example, a network interface such as ethernet or Wi-Fi, NFC, Bluetooth®, or the like. The printing device 130 may be, for example, a conventional printer such as a general-purpose printer, a label printer, a small-format printer, a dedicated postage printer, or any other suitable device.

As previously disclosed, the limited-function computing device 120 may include a physical user interface. As used herein, a “physical” interface refers to a user interface that includes one or more user interface items such as buttons, switches, displays, or the like, and which is integral to the limited-function computing device. A physical user interface may be contrasted to a software-only interface that only includes elements displayed on a screen such as windows, icons, and the like on a separate, general-purpose computer. In some embodiments a physical user interface may generate such elements on a touchscreen or comparable device. In some embodiments the physical user interface may be removable from the limited-function computing device by an end user, such as to replace one interface with another. In such embodiments, however, typically the limited-function computing device 120 and the user interface will be inoperable or essentially inoperable unless the components are connected. In contrast, when a conventional general purpose computer is used as an interface to a PC Postage-type device, the general purpose computer is still operable when the PC Postage printer is disconnected.

A physical user interface as disclosed herein may include only a single control element. For example, the device may include only a single button by which a user may instruct the device to print a postage indicia, and no other interface elements or other mechanism for a user to interact with the limited-function device. Alternatively, the physical user interface may include additional controls to specify a quantity, value, or other attribute of postage indicia to be printed. For example, the user interface may include one or more buttons and one or more displays, such as LCDs, screens, or the like, which allow a user to select a number of postage indicia to be printed and/or a value for each indicia. As a specific example, if a user intends to print five indicia, each having a value of $1.09, the user may enter each value via an associated interface so that an LCD indicator displays a quantity of “5” and a value of “1.09” or the like. In some embodiments, a device may provide or store pre-set and/or user defined values for postage indicia, such as particular values set as “favorites” that are commonly used by the user, or for specific classes of mail as defined by a postal services vendor. For example, the device may include pre-set postage values for various classes of mail as defined by the US Postal Service, from which the user may select when printing an indicia.

In an embodiment, the limited-function computing device 120 may include a position location module, such as a global positioning service (GPS) receiver or similar. Such a component may be used to determine the location of the device, for example to identify a closest point of entry into a mail stream such as a closest pickup point for a carrier service or similar, determine a distance that a mail piece will be transported to reach a destination identified on an indicia to be printed by the device, or a combination thereof in order to determine an appropriate value of postage to be printed. The limited-function device 120 may use this information to generate the postage indicia that is sent to the printing device to be printed.

FIGS. 1C and 1D show examples of limited-function computing devices according to embodiments disclosed herein. In FIG. 1C, a limited-function computing device 120 includes a physical user interface 121, in this case a single button. The device 120 is in communication with a printing device 130 over any suitable communication link 140 and associated protocol. The printing device 130 which can dispense postage indicia 132 upon actuation of a part of the physical user interface 121 as previously disclosed. In this example, the two components 120, 130 may be provided separately, such as where the device 120 is provided by a postal service provider and the printing device 130 is a generic printing device.

As another example, a limited-function computing device 120 as disclosed herein may include a printing device 130 as part of an integral unit. FIG. 1D shows an example of such a device. In this case, the single device 120 includes the physical user interface 121 and a built-in printing device that can dispense indicia 132 upon actuation of the interface 121 as previously disclosed.

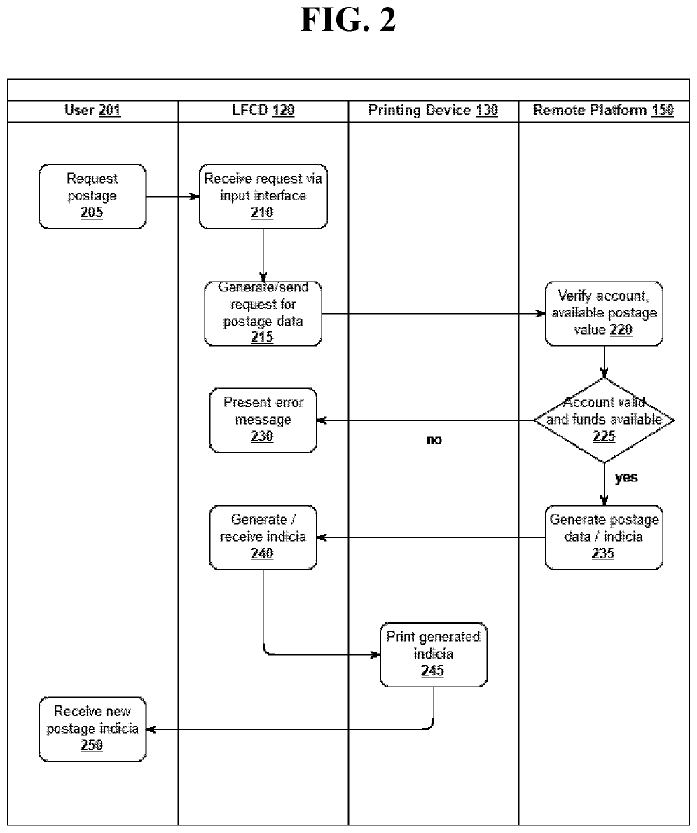

FIG. 2 shows an example communication flow for generating postage indicia using a limited-function computing device 120 and local printer as disclosed herein. At 205, a user 201 may request one or more postage indicia, such as by actuating a user interface component on a limited-function computing device 120 as previously disclosed. The request may be received and processed by the device 120 at 210. At 215, the device may send a request to the remote platform 150 indicating the amount, number, and/or type of postage indicia to be printed. At 220, the remote platform system 150 may verify that an adequate amount of stored funds is available in a user account associated with the device 120. The platform 150 also may verify that the request is legitimate, such as by verifying a digital signature of the device 120 included in the request, verifying the form and/or network source of the request, or the like. At 225, if the request is not validated or there is insufficient stored funds available in a user account associated with the device 120, the platform 150 may return an error message or an indication that an indicia cannot be printed, which may be displayed by the device 120 at 230. Alternatively or in addition, as previously disclosed the remote platform 150 may have access to an automatic replenishment mechanism such as by accessing a funding source previously authorized by the user.

If the request is validated and sufficient stored funds are available in the user account associated with the device, at 235 the remote platform may generate a postage indicia or data sufficient to generate a postage indicia. In an embodiment in which the user requested a specific value and/or quantity of postage indicia, the requested number and/or value of indicia, or data sufficient to generate such indicia, may be generated at 235. The indicia or postage data may be sent to the device 120. If the remote platform 150 generates the postage indicia, the indicia may be received by the device 120 at 240. Similarly, the remote platform 150 may generate data sufficient to generate the postage indicia and the device 120 may generate the actual postage indicia, such as by generating an appropriate image to be printed by the printer. Regardless of which component generates the indicia, at 245 the device may transfer the indicia to the printing device 130 to be printed, after which it may be received by the user at 250. The indicia may be, for example, an image such as a bar code, QR code, IBI- and/or IMI-type image as defined and authorized by the United States Postal Service or similar regulatory entity, and other indicia formats, or any other image or combination of image and text sufficient to allow a mail piece bearing the indicia to be transported through a mail stream. The indicia may include any conventional information commonly included in such indicia, such as routing information, source/destination information, postage amount, validation data, and the like.

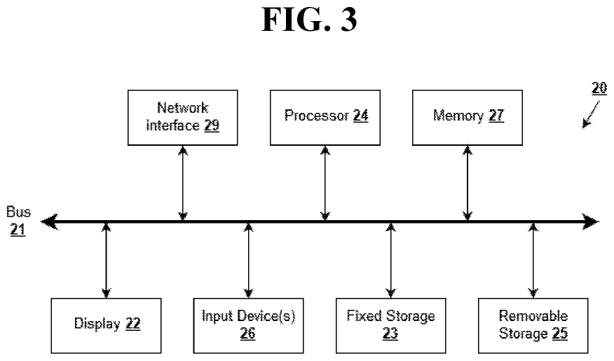

Embodiments of the presently disclosed subject matter may be implemented in and used with a variety of component and network architectures. FIG. 3 is an example general-purpose computing device 20 suitable for implementing aspects of the presently disclosed subject matter as previously disclosed. The device 20 may be, for example, a desktop or laptop computer, a mobile computing device such as a phone or tablet, or the like. The device 20 may include a bus 21 which interconnects major components of the computer 20, such as a central processor 24, a memory 27 such as Random Access Memory (RAM), Read Only Memory (ROM), flash RAM, or the like, a user display or other output device 22 such as a display screen, one or more user input devices 26, which may include one or more controllers and associated user input devices such as a keyboard, mouse, touch screen, and the like, a fixed storage 23 such as a hard drive, flash storage, and the like, a removable storage unit 25 operative to control and receive an optical disk, flash drive, and the like, and a network interface 29 operable to communicate with one or more remote devices via a suitable network connection.

The bus 21 allows data communication between the central processor 24 and one or more memory components. Applications resident with the computing device 20 are generally stored on and accessed via a computer readable medium, such as a fixed storage 23 and/or a removable storage 25 such as an optical drive, floppy disk, or other storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, Wi-Fi, Bluetooth®, NFC, and the like. For example, the network interface 29 may allow the computer to communicate with other computers via one or more local, wide-area, or other communication networks, as described in further detail below.

As previously disclosed, a limited-function computing device as disclosed herein may differ from a general-purpose computing device as shown in FIG. 3 in that it may not include as many or the same components, though some components may be similar or identical in form and/or function. Furthermore, a limited-purpose computing device generally will not allow for a user to load and execute arbitrary software via the fixed storage 23, removable storage 25, and/or the network interface 29. For example, a user of a general-purpose computer typically can download or access any desired software via the network interface 29 or the removable storage 25, which may be stored for execution by the processor 24 in the fixed storage 23 and/or the memory 27. In contrast, a limited-function computing device as disclosed herein may not allow the user to obtain and install arbitrary software on the device. For example, the limited-function computing device may not allow software to be stored in the fixed storage 23 and/or executed by the processor 24. In some cases the software installed on the device may be updated via a remote platform as previously disclosed, but such updates may be restricted based on the presence of a cryptographic key or other security measure that restricts installation of the updates to the remote platform or other similar entity. A limited-function computing device also may exclude a removable storage 25 and/or a fixed storage 23 as such, and the user input devices 26 may be limited-function interfaces as previously disclosed herein.

A limited-function computing device as disclosed herein may be implemented partially or entirely within an “Internet of things” (IoT) style device such as an Azure Sphere® device as provided by Microsoft® Corporation of Seattle, Wash. or any similar device.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general-purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A system comprising:
a limited-function computing device comprising:
a remote communication interface capable of being configured to communicate with a remote postage platform;
a first local communication interface;
a physical user interface;
a processor configured to receive input via the physical user interface and to send and receive electronic communications via the remote communication interface and the first local communication interface; and
a printing device comprising:
a second local communication interface capable of being configured to communicate with the limited-function computing device via the first local communication interface; and
a printer;
wherein the limited-function computing device is capable of being configured to send postage indicia to the printing device to be printed in response to receiving an input via the physical user interface.

2. The device of claim 1, wherein the limited-function computing device generates the postage indicia.

3. The device of claim 1, wherein the remote postage platform generates the postage indicia in response to a request from the limited-function computing device.

4. The device of claim 1, wherein the physical user interface consists essentially of a single control element.

5. The device of claim 4, wherein the single control element is a single button.

6. The device of claim 1, wherein the physical user interface comprises a component for indicating a quantity of indicia to be printed.

7. The device of claim 6, wherein the physical user interface comprises a component for selecting a postage value for each of the indicia to be printed.

8. The device of claim 1, wherein the physical user interface comprises a component for selecting a postage value for the indicia to be printed.

9. The device of claim 1, wherein the limited-function computing device is capable of being configured via a separate general-purpose computer.

10. The device of claim 1, wherein the limited-function computing device is capable of being configured to communicate only with a single remote computing system.

11. The device of claim 1, wherein the limited-function computing device further comprises a position location module.

12. The device of claim 11, wherein the position location module comprises a global positioning service (GPS) receiver.

13. The device of claim 11, wherein the processor generates the postage indicia for printing by the printer based on a position of the device.

14. The device of claim 1, wherein the processor generates an image of the postage indicia for printing by the printer.

15. The device of claim 14, wherein the data from the remote postage payment platform comprises indicia data that the processor uses to generate the postage indicia.

16. The device of claim 1, wherein the limited-function computing device receives the postage indicia from the remote postage payment platform.

17. A limited-function computing device comprising:
a remote communication interface capable of being configured to communicate with a remote postage platform;
a first local communication interface capable of being configured to communicate with a device physically connected to the limited-function computing device;
a physical user interface; and
a processor configured to receive input via the physical user interface and to send and receive electronic communications via the remote communication interface and the first local communication interface;
wherein the limited-function computing device is capable of being configured to send a postage indicia to a printer via the first local communication interface in response to receiving an input via the physical user interface.

18. The device of claim 17, wherein the postage indicia are generated by the limited-function computing device.

19. The device of claim 18, wherein the postage indicia is generated based upon data received by the limited-function computing device from the remote postage platform.

20. The device of claim 17, wherein the postage indicia is generated by the remote postage platform in response to a request received from the limited-function computing device.

21. The device of claim 17, further comprising the printer.

22. A method comprising:
receiving an input signal via a physical user interface by a limited-function computing device;
verifying that sufficient funds exist, in an account linked to the limited-function computing device, to generate a postage indicia; and
responsive to the input signal and the verifying, instructing a printing device to print a postage indicia.
